(19) United States
(12) Patent Application Publication
(10) Pub. No.: US 2020/0086791 A1
(43) Pub. Date: Mar. 19, 2020

(54) APPARATUS AND METHOD FOR DISPLAYING INFORMATION

(71) Applicant: JAGUAR LAND ROVER LIMITED, COVENTRY, WARWICKSHIRE (GB)

(72) Inventor: ROBERT HARDY, Warwickshire (GB)

(21) Appl. No.: 16/469,964

(22) PCT Filed: Jan. 23, 2018
(86) PCT No.: PCT/EP2018/051525

§ 371 Date: Jun. 14, 2019

(30) Foreign Application Priority Data
Feb. 16, 2017 (GB) 1702538.8

(51) Int. Cl. B60R 1/00; G06T 7/73; G06T 5/50

(52) U.S. Cl. CPC B60R 1/00; G06T 7/73; G06T 5/50; G06T 2207/20221; B60R 2300/60; B60R 2300/105; G06T 2207/30252; B60R 2300/304

(57) ABSTRACT

Embodiments of the present invention provide a display method for use in a vehicle. The method comprises obtaining a first image showing a region external to the vehicle from a first image capture device. An obscured region of the first image for which a portion of the field of view of the first image is obscured, at least in part, is detected (1000). Image data in a second image corresponding to the obscured region is identified (1012). A composite image from the first image and the identified image data is generated (1014). At least part of the composite image is displayed (1016). A corresponding display apparatus, for use in a vehicle, to implement the method is also provided, along with a computer program product storing computer program code which is arranged when executed to implement the method and a vehicle including the apparatus.

### TECHNICAL FIELD

The present invention relates to an apparatus and method for displaying information. Particularly, but not exclusively, the present invention relates to a display method for use in a vehicle and a display apparatus for use in a vehicle. Aspects of the invention relate to a display method, a computer program product, a display apparatus and a vehicle.

### BACKGROUND

Cameras mounted on or in a vehicle, arranged to view an area external to the vehicle, often have their view of the surroundings obscured by dust and dirt covering the lens of the camera or the window behind which the camera is located. Clearly this phenomenon is understandable, especially to a user that has been/is driving the vehicle off-road. Nonetheless, when the driver can no longer use the camera view because dirt is obscuring the camera, they are forced to either operate the vehicle without the useful features the cameras provide, or get out of the car to clean the lens. If this occurs frequently it will quickly become a source of irritation to the user.

One example of a vehicle-mounted camera is a reversing camera. Typically, a single camera mounted on the rear of the vehicle is used to enhance the view of the area rear of the vehicle for the driver whenever they perform a reversing manoeuvre. Due to the location of reversing cameras, dirt and water is commonly splashed or blown onto the lens during normal driving, necessitating regular cleaning of the lens. Another example of vehicle camera systems comes in the form of surround view camera systems. These systems take image data from multiple cameras mounted around the vehicle and stitch together the views of these cameras to provide a substantially 360 degree view around the vehicle. These surround view camera systems are particularly useful for helping a driver to park a large vehicle in a tight parking space or when driving a vehicle off-road on difficult terrain. In such situations it would be better if the driver could make the desired manoeuvre in the vehicle with the aid of the cameras rather than forcing them to stop the vehicle and clean the camera lenses before the manoeuvre can be completed.

It is known to tackle the problem of obscured cameras through the use of cleaning systems for the camera lenses or the windows behind which the cameras are located. Such cleaning systems include wiping the lens or window with a rubber blade or squirting a washing fluid or air whenever the view is deemed obstructed by dirt. However, such systems can be particularly difficult to package in a vehicle and add to the overall maintenance cost of the vehicle. An alternative known approach to tackle this problem is the use of hydrophobic coatings applied to camera lenses or windows to reduce the build-up or dirt and dust. However, such coatings may degrade over the life time of a vehicle and increase the maintenance cost if they are to be reapplied.

It is an object of the present invention to overcome at least some of the aforementioned problems and enhance the benefits that vehicle mounted camera systems can provide to the driver.

It is an object of embodiments of the invention to at least mitigate one or more of the problems of the prior art including the aforementioned problems. It is an object of certain embodiments of the invention to provide a method for providing temporary compensation for a partially obscured camera lens on a vehicle. According to certain embodiments of the invention, this object is achieved by detecting dirt or anything else obscuring part of a camera field of view through the use of software and then filling in the obscured portion from historic image data or image data from another camera.

### SUMMARY OF THE INVENTION

Aspects and embodiments of the invention provide a display method, a computer program product, a display apparatus and a vehicle as claimed in the appended claims.

According to an aspect of the invention, there is provided a display method for use in a vehicle, the method comprising: obtaining a first image showing a region external to the vehicle from a first image capture device; detecting an obscured region of the first image for which a portion of the field of view of the first image is obscured at least in part; identifying image data in a second image corresponding to the obscured region;

generating a composite image from the first image and the identified image data; and displaying at least part of the composite image.

Detecting an obscured region may comprise comparing the first image to a further image obtained from the same image capture device, the first and further images being captured at different points in time.

Detecting an obscured region may further comprise detecting corresponding portions of the first image and the further image which are the same while other corresponding portions of the first image and the further image differ.

Detecting an obscured region may further comprise defining a boundary encompassing said corresponding portions of the first image and the further image which are the same.

The second image may be obtained from the first image capture device or a second image capture device having a different field of view relative to the first image capture device, the first and second images being captured at different points in time.

The second image may be obtained from a second image capture device at the time of capture of the first image, the fields of view of the first and second image capture devices overlapping and the region of overlap at least partially encompassing the obscured region.

The first or second image capture devices may be mounted upon or within the vehicle to capture images of the environment external to the vehicle.

The display method may further comprise: determining positions of the vehicle at the time the first and second images are captured; and storing an indication of the positions of the vehicle.

Generating a composite image may comprise matching portions of the first image and the second image.

Matching portions of the first image and the second image may comprise matching overlapping portions of the first image and the second image.

Matching portions of the first image and the second image may comprise performing pattern matching to identify features present in both the first image and the second image such those features are correlated in the composite image.

The display method may further comprise determining a pattern recognition region within the first image including the obscured region; and determining a second image including image data for the environment within the pattern recognition area.

Determining a pattern recognition region may comprise determining coordinates for the pattern recognition region according to a current position of the vehicle.

Determining a pattern recognition region may further include receiving a signal indicating an orientation of the vehicle and adjusting the pattern recognition region coordinates according to the vehicle orientation.

The display method may further comprise: obtaining at least one image property for each of the first and second images; calculating an image correction factor as a function of the at least one image property for each of the first and second images; and adjusting the appearance of the first image or the second image according to the calculated image correction factor.

The at least one image property may be indicative of a characteristic of the image, a setting of an image capture device used to capture the image or an environmental factor at the time the image was captured.

Generating a composite image may further comprise indicating the portion of the composite image corresponding to the obscured region.

Generating a composite image may further comprise using identified image data from the second image and at least one third image within the obscured region.

The display method may further comprise storing at least a predetermined number of images obtained from the first image capture device at different points in time.

According to a further aspect of the invention, there is provided a computer program product storing computer program code which is arranged when executed to implement the above method.

According to a further aspect of the invention, there is provided a display apparatus for use with a vehicle, comprising: a first image capture device arranged to obtain a first image showing a region external to the vehicle; a display means arranged to display a composite image; and a processing means arranged to: detect an obscured region of the first image for which a portion of the field of view of the first image capture device which is obscured at least in part; identify image data in a second image corresponding to the obscured region; generate a composite image from the first image and the identified image data; and cause the display means to display at least part of the composite image.

A display apparatus as described above, wherein the image capture device comprises a camera or other form of device arranged to generate and output still images or moving images. The display means may comprise a display screen, for instance a LCD display screen suitable for installation in a vehicle. Alternatively, the display may comprise a projector for forming a projected image. The processing means may comprise a controller or processor, suitably the vehicle ECU.

The processing means may be further arranged to implement the above method.

According to a further aspect of the invention, there is provided a vehicle comprising the above display apparatus.

According to a further aspect of the invention, there is provided a display method, a display apparatus or a vehicle substantially as herein described with reference to FIGS. 10, 6 and 1 respectively of the accompanying drawings.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying figures, in which:

FIG. 1 illustrates a portion of a vehicle including a vehicle mounted camera system;

FIG. 2 illustrates a composite 3D image derived from vehicle mounted cameras;

FIG. 3 illustrates a composite 2D image, specifically a bird's eye view, derived from vehicle mounted cameras;

FIG. 4 illustrates a method for providing a composite image;

FIG. 5 illustrates a composite 2D image, specifically a bird's eye view, showing the tracking of a moving vehicle;

FIG. 6 illustrates an apparatus for implementing the method of FIG. 4;

FIG. 7 illustrates a system for forming a composite image including the adjustment of image properties;

FIG. 8 illustrates a method of forming a composite image including the adjustment of image properties;

FIG. 9 illustrates a field of view from a first image obtaining means including obscured regions; and

FIG. 10 illustrates a method of forming a composite image to compensate for obscured image regions according to an embodiment of the invention.

### DETAILED DESCRIPTION

It is becoming commonplace for vehicles to be provided with one or more video cameras to provide live video images (or still images) of the environment surrounding a vehicle. The vehicle may be a land-going vehicle, such as a wheeled vehicle including a display means to display captured images. The display means may comprise a head-up display means for displaying information in a head-up manner to at least the driver of the vehicle, or any other form of display means such a display screen or a projection means. The projection means may be arranged to project an image onto an interior portion of the vehicle, such as onto a dashboard, door interior, or other interior components of the vehicle. In the following discussion, where reference is made to the view of the driver or from the driver's position, this should be considered to encompass the view of a passenger, though clearly for manually driven vehicles it is the driver's view that is of paramount importance. Such images may then be displayed for the benefit of the driver, for instance on a dashboard mounted display screen. In particular, it is well-known to provide at least one camera towards the rear of the vehicle directed generally behind the vehicle and downwards to provide live video images to assist a driver who is reversing (it being the case that the driver's natural view of the environment immediately behind the vehicle is particularly limited). It is further known to provide multiple such camera systems to provide live imagery of the environment surrounding the vehicle on multiple sides, for instance displayed on a dashboard mounted display screen. For instance, a driver may selectively display different camera views in order to ascertain the locations of objects close to each side of the vehicle.

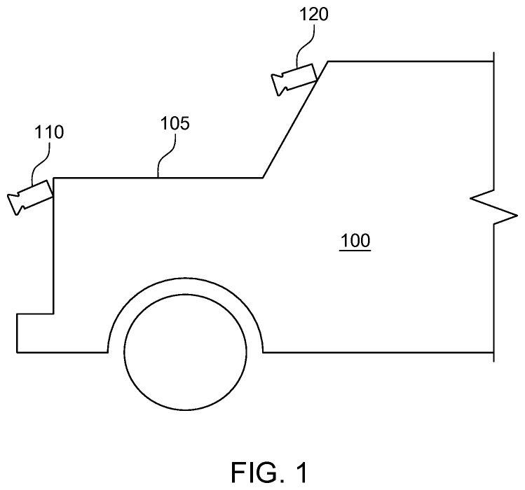

Such cameras may be positioned externally and mounted upon the exterior of the vehicle, or internally viewing through the windscreen or other vehicle glass in order to capture images, their lenses directed outwards and downwards. Such cameras may be provided at varying heights, for instance generally at roof level, driver's eye level or some suitable lower location to avoid vehicle bodywork obscuring their view of the environment immediately adjacent to the vehicle. FIG. 1 provides an example of a camera that is mounted upon a front of the vehicle to view forwards there-from in a driving direction of the vehicle. Where the images concerned are to another side of the vehicle then clearly the camera position will be appropriately located.

As shown in FIG. 1, which illustrates a front portion of a vehicle 100 in side-view, a camera 110 is mounted at a front of the vehicle lower than a plane of a hood or bonnet 105, such as behind or above a grill of the vehicle 100. Alternatively, or in addition, a camera 120 may be positioned above the plane of the bonnet 105, for instance at roof level or at an upper region of the vehicle's windscreen. It will be appreciated that cameras may alternatively be provided on the rear of a vehicle for assisting a driver whilst reversing or performing other manoeuvres, or may be provided at other positions, for instances facing generally to one side of the vehicle. The field of view of each camera may be generally outwards and downwards relative to an occupant compartment of the vehicle, to output image data for a portion of the environment surrounding the vehicle including the ground adjacent to the vehicle. It will be realised that the camera may be mounted in other locations, and may be moveably mounted, for instance to rotate about an axis such that a viewing angle of the camera is vertically or horizontally controllable.

Advantageously, image data from multiple vehicle mounted cameras may be combined to form a composite image, expanding the view available to the driver. This may be used to address the problem that it can be hard for a driver to ascertain the position of the vehicle relative to objects underneath the vehicle. There will now be described a method for enabling a driver to view the terrain underneath a vehicle through the use of historic (that is, time delayed) video footage obtained from a vehicle camera system, for instance the vehicle camera system illustrated in FIG. 1. A suitable vehicle camera system comprises one or more video cameras positioned upon a vehicle to capture video images of the environment surrounding the vehicle which may be displayed to aid the driver.

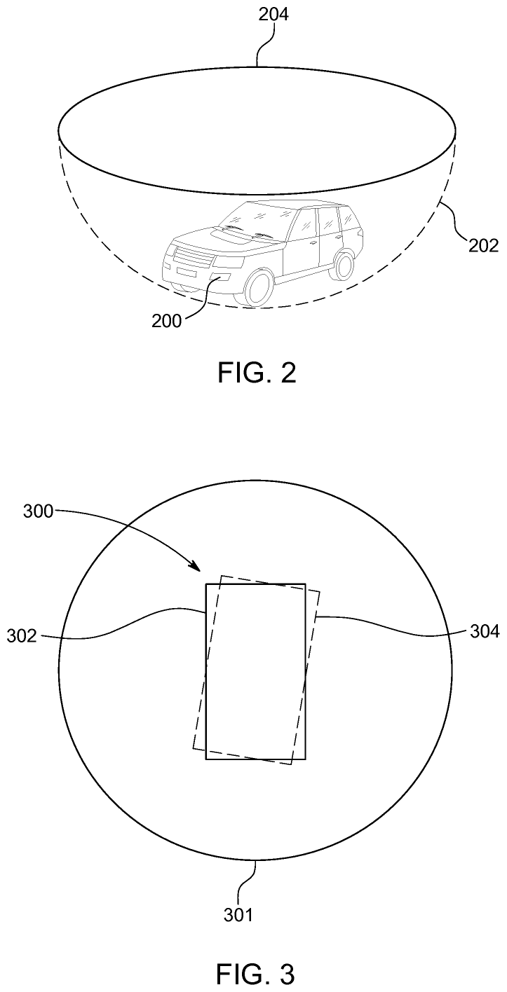

It is known to take video images (or still images) derived from multiple vehicle mounted cameras and form a composite image illustrating the environment surrounding the vehicle. Referring to FIG. 2, this schematically illustrates such a composite image surrounding a vehicle 200. Specifically, the multiple images may be combined to form a 3-Dimensional (3D) composite image that may, for instance, be generally hemispherical as illustrated by outline 202. This combination of images may be referred to as stitching. The images may be still images or may be live video images. The composite image is formed by mapping the images obtained from each camera onto an appropriate portion of the hemisphere. Given a sufficient number of cameras, and their appropriate placement upon the vehicle 200 to ensure appropriate fields of view, it will be appreciated that the composite image may thus extend all around the vehicle 200 and from the bottom edge of the vehicle 200 on all sides up to a predetermined horizon level illustrated by the top edge 204 of hemisphere 202. It will be appreciated that it is not essential that the composite image extends all of the way around the vehicle 200. For instance, in some circumstances it may be desirable to stitch only camera images projecting generally in the direction of motion of the vehicle 200 and to either side—directions where the vehicle 200 may be driven. This hemispherical composite image may be referred to as a bowl. Of course, the composite image may not be mapped to an exact hemisphere as the images making up the composite may extend higher or lower, or indeed over the top of the vehicle 200 to form substantially a composite image sphere. It will be appreciated that the images may alternatively be mapped to any 3D shape surrounding the vehicle 200, for instance a cube, cylinder or more complex geometrical shape, which may be determined by the number and position of the cameras. It will appreciate that the extent of the composite image is determined by the number of cameras and their camera angles. The composite image may be formed by appropriately scaling and/or stretching the images derived from each camera to fit to one another without leaving gaps (though in some cases gaps may be left where the captured images do not encompass a 360 degree view around the vehicle 200).

The composite image may be displayed to the user according to any suitable display means, for instance the Head Up Display, projection systems or dashboard mounted display systems described above. While it may be desirable to display at least a portion of the 3D composite image viewed for instance from an internal position in a selected viewing direction, optionally a 2-Dimensional (2D) representation of a portions of the 3D composite image may be displayed. Alternatively, it may be that a composite 3D image is never formed—the video images derived from the cameras being mapped only to a 2D plan view of the environment surrounding the vehicle 200. This may be a side view extending from the vehicle 200, or a plan view such as is shown in FIG. 3.

FIG. 3 shows a composite image 301 giving a bird's eye view of the environment surrounding a vehicle indicated generally at 300, also referred to as a plan view. Such a plan view may be readily displayed upon a conventional display screen mounted inside the vehicle 300 and provides useful information to the driver concerning the environment surrounding the vehicle 300 extending up close to the sides of the vehicle 300. From the driving position it is difficult or impossible to see the ground immediately adjacent to the vehicle 300 and so the plan view of FIG. 3 is a significant aid to the driver. The ground underneath the vehicle 300 remains obscured from a camera live view and so may typically be represented in the composite image 301 by a blank region 302 at the position of the vehicle 300, or a representation of a vehicle to fill the blank. Without providing cameras underneath the vehicle 300, which is undesirable as discussed above, for a composite image formed solely from stitched live camera images, the ground underneath the vehicle 300 cannot be seen.

In addition to the cameras being used to provide a composite live image of the environment surrounding the vehicle 300, historic images may be incorporated into the composite image to provide imagery representing the terrain under the vehicle—that is, the terrain within the boundary of the vehicle 300. By historic images, it is meant images that were captured previously by the vehicle camera system, for instance images of the ground in front of or behind the vehicle 300; the vehicle subsequently having driven over that portion of the ground. The historic images may be still images or video images or frames from video images. Such historic images may be used to fill the blank region 302 in FIG. 3. It will be appreciated that, particularly for off road situations, the ability to see the terrain in the area under the vehicle (strictly, a representation of the terrain derived from historic images captured before the vehicle obscured the terrain) allows the driver to perform fine adjustment of the vehicle position and in particular the vehicle wheels and enhances the driver's confidence in controlling the vehicle.

The composite image may be formed by combining the live and historic video images, and in particular by performing pattern matching to fit the historic images to the live images thereby filling the blind spot in the composite image comprising the area under the vehicle. The surround camera system comprises at least one camera and a buffer arranged to buffer images as the vehicle progresses along a path. The vehicle path may be determined by any suitable means, including but not limited to a satellite positioning system such as GPS (Global Positioning System), IMU (Inertial Measurement Unit), wheel ticks (tracking rotation of the wheels, combined with knowledge of the wheel circumference) and image processing to determine movement according to shifting of images between frames. At locations where the blind spot from the live images overlaps with buffered images, the area of the blind spot copied from delayed video images is pattern matched through image processing to be combined with the live camera images forming the remainder of the composite image.

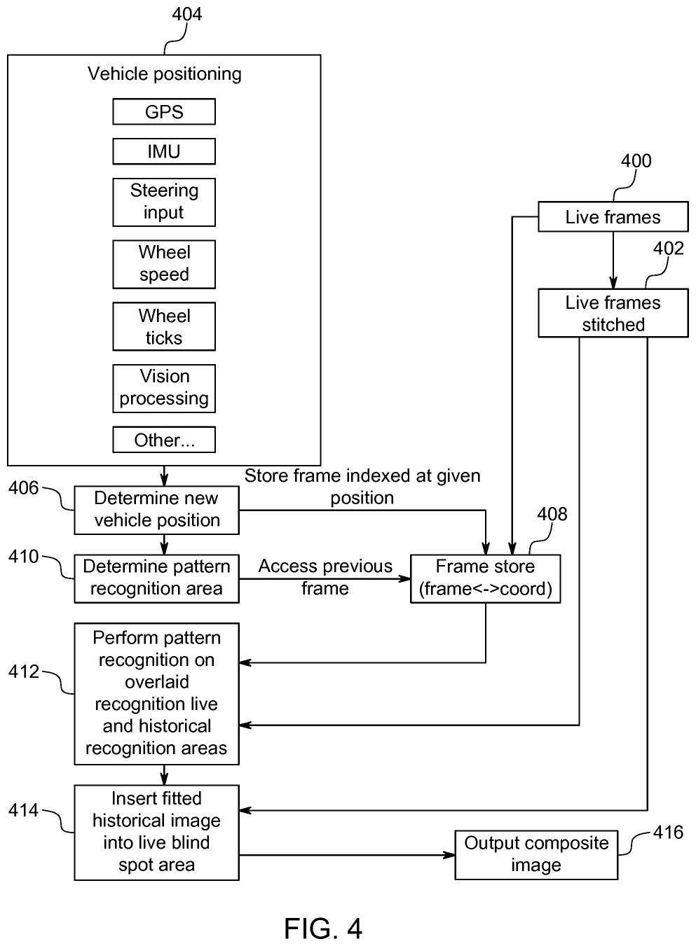

Referring now to FIG. 4, this illustrates a method of forming a composite image from live video images and historic video images. At step 400 live video frames are obtained from the vehicle camera system. The image data may be provided from one or more cameras whose field of view are directed outwards from the vehicle, as previously explained. In particular, one or more cameras may be arranged to view in a generally downward direction in front of or behind the vehicle at a viewing point a predetermined distance ahead of the vehicle. It will be appreciated that such cameras may be suitably positioned to capture images of portions of the ground which may later be obscured by the vehicle.

At step 402 the live frames are stitched together to form the composite 3D image (for instance, the image “bowl” described above in connection with FIG. 4) or a composite 2D image. Suitable techniques for so combining video images will be known to the skilled person. It will be understood that the composite image may be formed continuously according to the 3D images or processed on a frame-by-frame basis. Each frame, or perhaps only a portion of the frames such as every n^{th} frame for at least some of the cameras, is stored for use in fitting historical images into a blank region of the composite image currently displayed (this may be referred to as a live blind spot area). For instance, where the bird's eye view composite image 301 of FIG. 3 is displayed on a screen, the live blind spot area is portion 302.

To constrain the image storage requirements, only video frames from cameras facing generally forwards (or forwards and backwards) may be stored as it is only necessary to save images of the ground in front of the vehicle (or in front and behind) that the vehicle may subsequently drive over in order to supply historic images for inserting into the live blind spot area. To further reduce the storage requirements it may be that not the whole of every image frame is stored. For a sufficiently fast stored frame rate (or slow driving speed) there may be considerable overlap between consecutive frames (or intermittent frames determined for storage if only every nth frame is to be stored) and so only an image portion differing from one frame for storage to the next may be stored, together with sufficient information to combine that portion with the preceding frame. Such an image portion may be referred to as a sliver or image sliver. It will be appreciated that other than an initially stored frame, every stored frame may require only a sliver to be stored. It may be desirable to periodically store a whole frame image to mitigate the risk of processing errors preventing image frames from being recreated from stored image slivers. This identification of areas of overlap between images may be performed by suitable known image processing techniques that may include pattern matching—that is, matching image portion of images common to a pair of frames to be stored. For instance, pattern matching may use known image processing algorithms for detecting edge features in images, which may therefore suitably identify the outline of objects in images, those outlines being identified in a pair of images to determine the degree of image shift between the pair due to vehicle movement.

Each stored frame, or stored partial frame (or image sliver) is stored in combination with vehicle position information. Therefore, in parallel to the capturing of live images at step 400 and the live image stitching at step 402, at step 404 vehicle position information is received. The vehicle position information is used to determine the vehicle location at step 406. The vehicle position may be expressed as a coordinate, for instance a Cartesian coordinate giving X, Y and Z positions. The vehicle position may be absolute or may be relative to a predetermined point. The vehicle position information may be obtained from any suitable known positioning sensor, for instance GPS, IMU, knowledge of the vehicle steering position and wheel speed, wheel ticks (that is, information about wheel revolutions), vision processing or any other suitable technique. Vision processing may comprise processing images derived from the vehicle camera systems to determine the degree of overlap between captured frames, suitably processed to determine a distance moved through knowledge of the time between the capturing of each frame. This may be combined with the image processing for storing captured frames as described above, for instance pattern matching including edge detection. In some instances it may be desirable to calculate a vector indicating movement of the vehicle as well as the vehicle position, to aid in determining the historic images to be inserted into the live blind spot area, as described below.

Each frame (or sliver) that is to be stored, from step 400, is stored in a frame store at step 408 along with the vehicle position obtained from step 406 at the time of image capture. That is, each frame is stored indexed by a vehicle position. The position may be an absolute position or relative to a reference datum. Furthermore, the position of image may be given relative only to a preceding stored frame allowing the position of the vehicle in respect of each historic frame to be determined relative to a current position of the vehicle by stepping backwards through the frame store and noting the shift in vehicle position until the desired historic frame is reached. Each record in the frame store may comprise image data for that frame (or image sliver) and the vehicle position at the time the frame was capture. That is, along with the image data, metadata may be stored including the vehicle position. The viewing angle of the frame relative to the vehicle position is known from the camera position and angle upon the vehicle (which as discussed above may be fixed or moveable). Such information concerning the viewing angle, camera position etc. may also be stored in frame store 408, which is shown representing the image and coordinate information as (frame <-> co-ord). It will be appreciated that there may be significant variation in the format in which such information is stored and the techniques disclosed herein are not limited to any particular image data or metadata storage technique, nor to the particulars of the position information that is stored.

At step 410 a pattern recognition area is determined. The pattern recognition area comprises the area under the vehicle that can't be seen in the composite image formed solely from stitched live images. Referring back to FIG. 3, the pattern recognition area comprises the blind spot 302. Coordinates for the pattern recognition area can be determined from the vehicle positioning information obtained at step 404 and as processed to determine the current vehicle position at step 406. Assuming highly accurate vehicle position information obtained at step 404, it will be appreciated that the current position of the vehicle may be exactly determined. Historic image data from frame store 408, that is, previously captured image frames, may be used to fill in blind spot 302 based on knowledge of the vehicle position at the time the historic images were captured. Specifically, the current blind spot may be mapped to an area of ground which is visible in historic images captured before the vehicle obscured that portion of the ground. The historic image data may be used through knowledge of the area of ground in the environment surrounding the vehicle in each camera image, as a result of the position of each camera upon the vehicle and the camera angle being known. As such, if the current vehicle position is known, image data showing the ground in the blind spot may be obtained from images captured at an earlier point in time before the vehicle obscures that portion of ground. Such image data may be suitably processed to fit the current blind spot and inserted into the stitched live frames. Such processing may include scaling and stretching the stored image data to account for a change in perspective from the outward looking camera angle to how the ground would appear if viewed directly from above. Additionally, such processing may include recombining multiple stored image slivers and/or images from multiple cameras.

However, the above described fitting of previous stored image data into a live stitched composite image is predicated on exact knowledge of the vehicle position both currently and when the image data is stored. It may be the case that it is not possible to determine the vehicle position to a sufficiently high degree of accuracy.

As an example, with reference to FIG. 3, the true current position of the vehicle (indicated generally at 300) is represented by box 302, whereas due to inaccurate position information the current vehicle position determined at step 406 may be represented by box 304. In the example of FIG. 3 the inaccuracy comprises the determined vehicle position being rotated relative to the true vehicle position. Equally, translational errors may occur. Errors in calculating the vehicle position may arise due to the vehicle wheels sliding, where wheel ticks, wheel speed and/or steering input are used to determine relative changes in vehicle position. Where satellite positioning is used it may be the case that the required level of accuracy is not available.

It will be appreciated that where the degree of error in the vehicle position differs between the time at which an image is stored and the time at which it is fitted into a live composite image this may cause undesirable misalignment of the live and historic images. This may cause a driver to lose confidence in the accuracy of the representation of the ground under the vehicle. Worse still, if the misalignment is significant then there may be a risk of damage to the vehicle due to a driver being misinformed about the location of objects under the vehicle.

Due to risk of misalignment, at step 412 pattern matching is performed within the pattern recognition area to match regions of live and stored images. As noted above in connection with storing image frames, such pattern matching may include suitable edge detection algorithms. The determined pattern recognition region at step 410 is used to access stored images from the frame store 408. Specifically, historic images containing image data for ground within the pattern recognition area is retrieved. The pattern recognition area may comprise the expected vehicle blind spot and a suitable amount of overlap on at least one side to account for misalignment. Step 412 further takes as an input the live stitched composite image from step 402. The pattern recognition area may encompass portions of the live composite view adjacent to the blind spot 302. Pattern matching is performed to find overlapping portions of the live and historic images, such that close alignment between the two can be determined and used to select appropriate portions of the historic images to fill the blind spot. It will be appreciated that the amount of overlap between the live and historic images may be selected to allow for a predetermined degree of error between the determined vehicle position and its actual position. Additionally, to take account of possible changes in vehicle pitch and roll between a current position and a historic position as a vehicle traverses undulating terrain, the determination of the pattern recognition region may take account of information from sensor data indicating the vehicle pitch and roll. This may affect the degree of overlap of the pattern recognition area with the live images for one or more sides of the vehicle. It may not always be necessary to determine a pattern recognition area, rather the pattern matching may comprise a more exhaustive search through historic images (or historic images with an approximate time delay relative to the current images) relative to the whole composite live image. However, by constraining the region within the live composite image within which pattern matching to historic images is to be performed, and constraining the volume of historic images to be matched, the computational complexity of the task and the time taken may be reduced.

At step 414 selected portions of one or more historic images or slivers are inserted into the blind spot in the composite live images to form a composite image encompassing both live and historic images.

Furthermore, in addition to displaying a representation of the ground under the vehicle, a representation of the vehicle may be added to the output composite image. For instance, a translucent vehicle image or an outline of the vehicle may be added. This may assist a driver in recognising the position of the vehicle and the portion of the image representing the ground under the vehicle.

Where the composite image is to be displayed overlying portions of the vehicle to give the impression of the vehicle being transparent or translucent (for instance using a HUD or a projection means as described above), the generation of a composite image may also require that a viewing direction of a driver of the vehicle is determined. For instance, a camera is arranged to provide image data of the driver from which the viewing direction of the driver is determined. The viewing direction may be determined from an eye position of the driver, performed in parallel to the other steps of the method. It will be appreciated that where the composite image or a portion of the composite image is to be presented on a display in the vehicle which is not intended to show the vehicle being see-through, there is no need to determine the driver's viewing direction.

The combined composite image is output at step 416. As discussed above, the composite image output may be upon any suitable image display device, such as HUD, dashboard mounted display screen or a separate display device carried by the driver. Alternatively, portions of the composite image may be projected onto portions of the interior of the vehicle to give the impression of the vehicle being transparent or translucent. The techniques disclosed herein are not limited to any particular type of display technology.

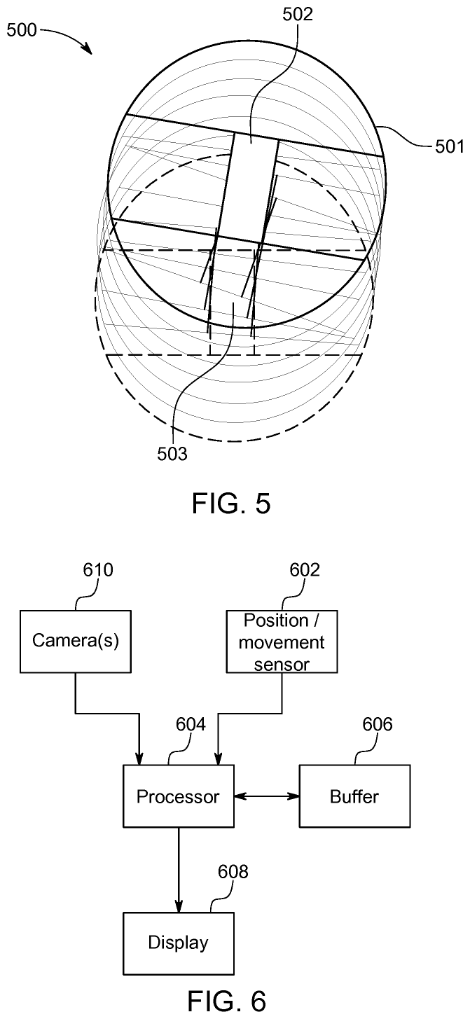

Referring now to FIG. 5, this illustrates the progression composites of live images 502 and historic images 503 as a vehicle 500 moves. In the example of FIG. 5 the composite image 501 is represented as a bird eye view above the vehicle and encompassing an 11 m bowl surrounding the vehicle 500, with the blind spot under the vehicle 500 being filled with historic images 503. FIG. 5 shows the composite image 501 tracking the vehicle location as it turns first right and then left (travelling from bottom to top in the view of FIG. 5), with the outline of each composite image being shown in outline. The current location of the vehicle is shown shaded. As noted above, the techniques disclosed herein are not limited to the presentation to the driver of a composite plan view of the car, its surroundings and the ground under the car. A 3D representation could be provided or any 2D representation derived from any portion of a 3D model, for instance that shown in FIG. 2, and viewed from any angle internal or external to the vehicle.

FIG. 6 illustrates an apparatus suitable for implementing the method of FIG. 4. The apparatus may be entirely contained within a vehicle. One or more vehicle mounted camera(s) 610 (for instance, that of FIG. 1) captures image frames used to form a live portion of a composite image or a historic portion of a composite image, or both. It will be appreciated that separate cameras may be used to supply live and historic images or their roles may be combined. One or more position or movement sensor 602 may be used to sense the position of the vehicle or movement of the vehicle. Camera 610 and sensor 602 supply data to processor 604 and are under the control of processor 604. Processor 604 buffers images from camera 610 in buffer 606. Processor 604 further acts to generate a composite image including live images received from camera 610 and historic images from buffer 606. The processor 604 controls a display 608 to display the composite image. It will be appreciated that apparatus of FIG. 6 may be incorporated within the vehicle of FIG. 1, in which case camera 610 may be provided by one or more of cameras 110, 120. Display 608 is typically located in the vehicle occupant compartment or cabin and may take the form of a dashboard mounted display, or any other suitable type, as described above. Some portions of the image processing may be performed by systems external to the vehicle.

As described above, the formation of a composite image comprises the stitching together of live and historic images derived from a vehicle camera system. This may be to provide a composite image having a wider field of view than is achievable using live images alone, for instance including images for portions or areas of the environment underneath the vehicle or otherwise not visible within live images due to that area being obscured by the vehicle itself. As described above, the combination of live and historic images may require the accurate tracking of the position of the vehicle at the time each image is recorded (including the live images). Alternatively, matching (for instance, pattern matching) portions of live and historic images can be used to determine which parts of historic images to stitch into a composite image.

Optionally, both techniques may be used as described in FIG. 4 in connection with determining a pattern recognition area. The first approach requires that vehicle position information is stored and associated with stored images.

To incorporate historic images into a composite image including live images as described above may involve a certain degree of image processing to scale and stretch historic images and/or live images to smoothly fit together. This may be true also for live images. However, the composite image may still appear disjointed. For an enhanced user experience, it may be desirable that the composite image has a uniform appearance such that it appears to have been captured by a single camera, or at least to minimise jarring differences between live and historic images are minimised. Such discontinuities may include colour and exposure mismatches. If uncorrected, composite image discontinuities may cause users to lose confidence in the accuracy of the information presented in a composite image, or to assume that there is a malfunction. It may be desirable that composite images appear to have been captured from a single camera, to give the appearance of the vehicle, or a portion of the vehicle, being transparent or translucent.

Such mismatches may result from changes in ambient lighting conditions between the time at which the live and historic images are captured (particularly when a vehicle is moving slowly) and changes in captured image properties arising from different camera positions (where multiple cameras are used and live or historic images are obtained from a different camera positions and stitched adjacent to one another) or apparently different camera positions following stretching and scaling of historic images. Furthermore, the problem of differences in image properties between live and historic images may be exacerbated by the wide field of view cameras used within vehicle camera systems. Multiple light sources around the vehicle, or changes in light sources between live and historic images, may cause further variation. For instance, at night time, portions of a live image may be illuminated by headlights. Historic images will also include areas illuminated by headlights at the time at which the images were captured. However, for the current position of the vehicle that portion of the environment (for instance under the vehicle) would no longer be illuminated by the vehicles headlights. Advantageously, this may serve to avoid the impression that areas under the vehicle in a composite image are being directly illuminated by headlights by ensuring that image properties for historic image portions match the image properties for adjacent live images.

Composite image discontinuities between live and historic images may be mitigated by adjusting the image properties of the historic images, live images or both to ensure a higher degree of consistency. This may provide an apparently seamless composite image, or at least a composite image where such seams are less apparent. In some cases it may be preferable to adjust the image properties of only historic images, or adjust the image properties of historic images to a greater extent than those of live images. This may be because by their very nature live images may include or be similar to regions directly observable by the driver and it may be desirable to avoid the composite image appearing dissimilar to the directly observed environment.

When images (or image slivers) are stored within a frame buffer or frame store, as described above in connection with step 408 of FIG. 4, the settings applied to the video image and/or captured image properties may also be stored. This may be alongside stored coordinate information. For instance, settings and captured image properties may be stored within an embedded data set of the image, as image metadata or separately and correlated within the stored images. At the time of combining live and historic images to form a composite image, the image properties or settings information may be compared between the live an historic image. The image properties of historic images, live images or both may be adjusted to reduce the appearance of discontinuity. It may be considered that this allows historic video data to be adapted to a live scene. Such image property adjustment may be across the whole of the historic or live images. Alternatively, image adjustment may be focused in the area of the seams or blended across image areas. As a further option, the whole or a substantial part of a historic image may be adjusted for consistency with images properties for images areas of a live image adjacent to the historic image in the stitched composite image. Advantageously, the last noted option may mitigate the effect of headlight illumination in historic images by adjusting their properties to conform to adjacent portions of a live image that are not directly illuminated by headlights. Each portion of historic or live image forming part of a composite image may be separately processed, or historic images and live portions may be treated as single areas for the purpose of image property adjustment.

When storing image properties an image processor may buffer a small number of frames, for instance four frames, and calculate average statistics to be stored in association with each frame. This may be performed for a rolling frame buffer. Additionally, or alternatively, this technique for averaging image properties across a small group of frames may be applied to live images to determine the image properties of live images for comparison with those of historic images. Advantageously, such averaging techniques mitigate against the possible negative effects of a single historic or live image including radically different image properties compared with preceding or subsequent images. Where the live images are averaged in this way each historic image or groups of historic images may be processed to match the current or rolling average image properties of live images. Specifically, taking the example of the image property under consideration being the image white balance (or more generally, colour balance), for each of a group of four live images the white balance WB may be calculated and averaged in accordance with equation (1) to give the average white balance AVG_{WB}. Appropriate statistical techniques for the calculation of an image white balance, or other colour balance property, will be well known or available to the skilled person.

(WB₁+WB₂+WB₃+WB₄)/4=AVG_{WB} (1)

From knowledge of the average white balance for a group of live images, the white balance for a historic image (H_{WB}) may be compared to determine a difference in white balance (X_{WB}) in accordance with equation (2). It will be appreciated that X_{WB} may be positive or negative.

H_{WB}−AVG_{WB}=X_{WB} (2)

Following the determination of the difference in white balance, the white balance of a historic image may be appropriately adjusted to conform to the live image average white balance in accordance with equation (3) to provide an adapted historic image white balance H_{WB}′. Appropriate techniques for adjusting the colour balance of an image will be known or available to the skilled person.

H_{WB}−X_{WB}=H_{WB} (3)

In equations (1) to (3) the respective WB or H_{WB} property may be for a whole image or a portion of an image. In equations (2) and (3) above it will be appreciated that the historic white balance may also comprise the average white balance for a group of historic images. In both cases the group size may differ from four. The technique described above in connection with equations (1) to (3) may be equally applied to any other image property, for instance image exposure. Image property information for historic images may be stored per image (or image sliver) or per group of images. Where average image properties are stored this may be separately performed for images from each camera or averaged across two or more cameras. The stored image properties may be averaged across fixed groups of images or taken from a rolling image buffer and stored individually for each historic image.

As noted previously, in an alternative to equation (3) it may be that after calculating the difference in image properties between historic images and live images, that difference is applied to the live images such that the live images match the historic images by adding (for the example of white balance) the white balance difference X_{WB} to the white balance WB for at least one live image. In some situations it may be disadvantageous to adjust the image properties of a live image. For instance, if a light source is within the field of view of a live image, adjusting the image properties of the live image to conform to a historic image could risk overexposure of the live image, resulting in the image appearing washed out. Additionally, as discussed above, it is desirable in some situations that live images appear as close as possible to how the environment surrounding the vehicle would appear if directly viewed by the driver.

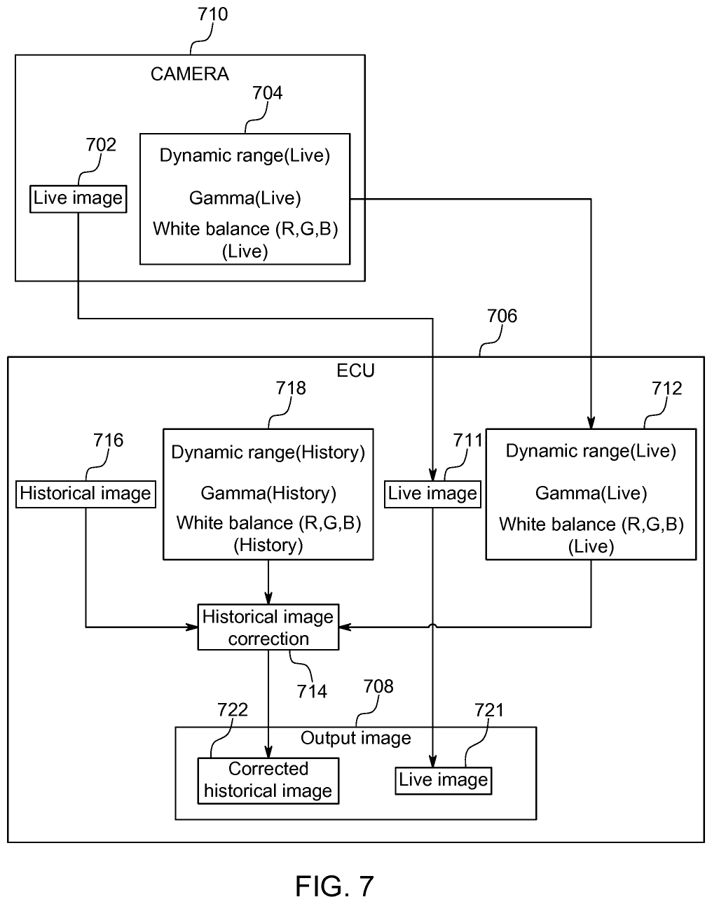

The adjustment of image properties for historic or live images may be performed as part of step 412 illustrated in FIG. 4 and described above, during which historical images are fitted into a live image blind spot area during formation of a composite image. Referring now to FIG. 7, a system for forming a composite image focusing on the adjustment of image properties to avoid composite image discontinuities will now be described. FIG. 7 may be considered to be an expansion of the camera 610 and processor 604 portions of FIG. 6. It will be appreciated that the descriptions of FIGS. 4 and 7 are complementary though intended to elucidate different aspects of the generation of a composite image. In particular, the detailed explanation presented above regarding the determination of a pattern recognition area and pattern recognition for overlaid live and historic images is applicable also to the image property adjustment as described below.

As previously described, a vehicle camera system may include one or more cameras 710. Camera 710 provides a live image as indicated at 702 and also provides an output 704 for one or more image property. The specific image properties identified in FIG. 7 at point 704, for live images, includes Dynamic Range, Gamma and White Balance (R,G,B). Further image properties (alternatively referred to herein as image characteristics) include Chroma and colour saturation. It will be appreciated that other image properties may be used or in any combination. Any image property or group of image properties that may be measured and adjusted to reduce image discontinuities in a composite image may be included, including image properties not explicitly listed. White Balance has been previously described. Colour balancing may be performed upon a three component image, for instance Red, Green, Blue. Any known measure of colour balance may be measured and output from camera 710 for a live image. Dynamic Range refers to the option for the camera 710 comprising a High Dynamic Range (HDR) camera in which multiple images are captured at different exposure levels. The dynamic range information indicates the range and/or absolute values for the exposure of each image. The multiple exposures may be combined to form a single image with a greater dynamic range of luminosity. Gamma is a measure of image brightness. It will be appreciated that alternative measures of image brightness may be used.

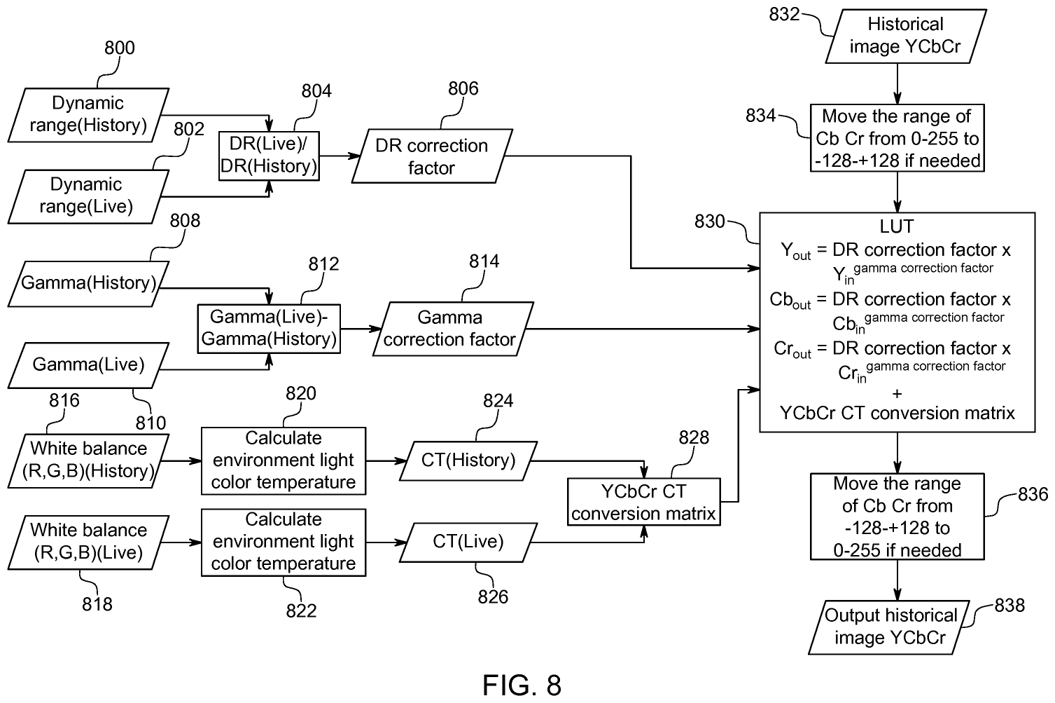

The live image data 702 and the corresponding image property data are supplied to the Electronic Control Unit (ECU) 706, though it will be appreciated that alternatively a separate image processing system may be used. The techniques disclosed herein may be implemented in any combination of hardware or software. Specifically, live images may be passed through directly to an output composite image 708 (for display on a vehicle display, for instance in the instrument cluster, and not illustrated in FIG. 7). Alternatively, at point 711 the live images may be processed for instance by appropriate scaling or stretching, or buffered, prior to being supplied to the output image 708. Similarly the image property data for live images is received at point 712. Live image data 712 is used by the ECU 706 as part of the historical image correction at point 714, for instance as described above in connection with equations (1) to (3) and as described in greater detail below in connection with FIG. 8. The historical image correction further takes as inputs stored historic images 716 and image property data 718 for historic images. The historic images 716 and image property data 718 for historic images may be buffered within the ECU 706 or separately buffered, for instance as shown in the separate buffer 606 of FIG. 6. It will be appreciated that the historic images 716 and the image property data 718 are ultimately derived from the camera system 710, though no direct connection is shown in FIG. 7 in the interests of simplicity.

The output image 708 includes both at least one live image 721 and at least one historic image 722, appropriately adjusted for consistency with the live image. The process whereby the images are stitched together to form an output composite image 708 has been described above in connection with FIG. 4.

Referring now to FIG. 8, a method for historic image correction will now be described in greater detail. Specifically, the method of FIG. 8 implements the historical image correction of part 714 of FIG. 7. The method takes as inputs a range of image properties for live and historic images. The method of FIG. 8 considers, for simplicity, a situation in which there is a single live and a single historic image to be presented side-by-side in a composite image and where it is desirable to adjust the image properties of the historic image or the live image. Three specific image properties are considered to perform this adjustment. Furthermore, FIG. 8 considers a situation in which each image property is calculated (and adjusted) in respect of the whole of each image. From the preceding discussion, the skilled person will readily appreciate how the method of FIG. 8 may be extensible to other situations in which multiple images are processed and/or only portions of images are processed, as well as alternative image properties being processed.

A first part of the image adjustment of FIG. 8 concerns the dynamic range of the live and historic images. The method receives as inputs a measure of the dynamic range for a historic image (step 800) and a measure of the dynamic range for a live image (step 802). Dynamic range of an image may be measured using a camera auto exposure control algorithm to adjust the exposure times based on the illumination of the scene. This exposure time-dynamic range relation may be unique to each sensor type because it is mainly dependent on sensitivity of the sensor and the auto exposure control algorithm of the Image Signal Processor (ISP).

At step 804 a dynamic range correction factor is calculated by dividing the dynamic range of the live image by the dynamic range of the historic image to provide a dynamic range correction factor 806. Dynamic Range (DR) is defined as DR=Lₛₐₜ/Lₘᵢₙ in ISO 15730 as a camera dynamic range calculation method. This terminology is used to describe the scene dynamic range by sensor and ISP suppliers, where they take Lₘᵢₙ as the noise floor of the sensor. Knowing Lₘᵢₙ will be constant for our sensor and exposure values and weightings will be adjusted so that Lₛₐₜ will be shown as digitally maximised in the image. A dynamic range correction can then be applied as gain to the formula.

Similarly, the method receives as inputs a measure of the gamma for a historic image (step 808) and a measure of the gamma for a live image (step 810). Gamma (also called a tone mapping curve) is provided by ISP or sensor suppliers as an adjustable curve vs DR. As the image is adapted to a new scene with a new DR, it is also necessary to compensate for gamma. Gamma is adaptive to the scene but it is acquired as part of an adaptive setting of a camera. It is not necessary to measure this from the camera, rather it may be dependent on the gamma calculation method of the ISP or sensor supplier. Gamma correction will be well known to the skilled person, for instance as described at https://en.wikipedia.org/wiki/Gamma_correction

At step 812 a gamma correction factor is calculated by subtracting the gamma of the historic image from the gamma of the live image to provide a gamma correction factor 814.

Similarly, the method receives as inputs a measure of the white balance for a historic image (step 816) and a measure of the white balance for a live image (step 818). Colour temperature of the light in the scene is detected to apply white balance. The objective of white balance is to apply a correction factor to the image so that the colour temperature of the light in the scene will appear as white in the image.

At steps 820 and 822 an environmental light colour temperature is calculated separately for each of the historic image and the live image. An auto white balance algorithm requires knowledge of the colour temperature of the scene to apply corrected white balance. This may be specific for different sensor and ISP suppliers. The calculated environment light colour temperature is then used to provide inputs 824 and 826 in respect of the colour temperature of each image. At step 828 the colour temperature of each image is used to determine a YCbCr conversion matrix, as will be well understood by the skilled person.

The dynamic range correction factor 806, the gamma correction factor 814 and the YCbCr conversion matrix 828 may then be applied to the historic image (or part of the historic image) to appropriately adjust the historic image for consistency with the live image. In the method of FIG. 8 this image adjustment is performed by a Look Up Table (LUT) 830, which advantageously reduces the computational demands placed upon the ECU or a separate image processing system. The LUT 830 takes as an input 832 the YCbCr information for a historic image. Specifically, the historic image data comprises YCbCr data in respect of each pixel. If required, this YCbCr data may be adjusted from a range of 0 to 255 for each pixel to a range of −128 to 128 for each pixel, at step 834. In some embedded systems, Cb and Cr data is stored from 0-255, where their range is defined in YCbCr colour space from −128 to +128. Cb and Cr data format in an embedded system is implementation specific and so step 834 may not be required or may differ for different implementations. The LUT then performs the image adjustment in respect of each pixel according to equation (4):

$${Y}_{out} = DR\_correction \_factor * {Y}_{in}^{gamma \_ correction \_ factor}$$

$${Cb}_{out} = DR\_correction \_factor * {Cb}_{in}^{gamma \_ correction \_ factor}$$

$${Cr}_{out} = DR\_correction \_factor * {Cr}_{in}^{gamma \_ correction \_ factor} + YCbCr CT Conversion Matrix$$

Step 830 comprises the application of the correction factors to a historic image after they are calculated. The CT conversion matrix may comprise a 3×3 correction matrix applied to the corrected Y, Cb and Cr values for each pixel of the historic image. A look up table may be generated by first calculating all values from 0-255 for all YCbCr values. This can simplify processing of the historic image may requiring only look up in the table instead of making the calculation for each pixel.

At step 836, if required the updated YCbCr data may be adjusted from a range of −128 to 128 for each pixel to a range of 0 to 255 for each pixel. In some embedded systems, Cb and Cr data is stored from 0-255, where their range is defined in YCbCr color space from −128 to +128. Cb and Cr data format in embedded system is implementation specific so step 836 may be omitted if modified for different implantations. At step 838 the updated historical image is output for further processing to be combined into a composite image, including by the pattern matching method of FIG. 4 or appropriate scaling and stretching (or this may precede the image property harmonisation method of FIG. 8).

It will be appreciated that the method of FIG. 8 is by way of example only and subject to modification according to the type and number of image properties which are calculated. In particular, the way in which image property correction factors are calculated and applied to image data may vary according to the image property types and desired degree of modification for historic images. As one example, calculated image property correction factors may be scaled to increase or decrease their effects, either in total or relative to other correction factors. As a further example, the correction factors may be scaled such that their effect varies across different areas of an image. Each image property may indicate a property of the image that can be derived or calculated from the image itself. Alternatively, an image property may indicate a setting of an imaging apparatus used to capture the image or an environmental factor prevailing when the image is captured, neither of which may be directly discernible from the image itself, but which may affect the appearance of the image.

The problem of portions of a camera field of view being obscured is described above. To summarise, if a camera lens, or a window through which a camera is directed in order to obtain its field of view, is dirty or otherwise obscured, then portions of images captured by that camera will be similarly obscured. This may make it harder for the driver to make out detail in the image of the environment surrounding the vehicle, and render the camera system less useful. To be clear, when a portion of an image or a portion of a camera field of view is described as being obscured, it is not necessary that all light has been blocked from reaching the camera in that portion. It may be that a portion of the image is missing, or it may be that a portion of an image is distorted or corrupted by a portion of the light being at least partially blocked and thus prevented from reaching the camera. Furthermore, it may be that within an obscured portion some smaller areas of the camera field of view are not obscured, but in general a sizable proportion of that portion of the camera field of view is obscured.

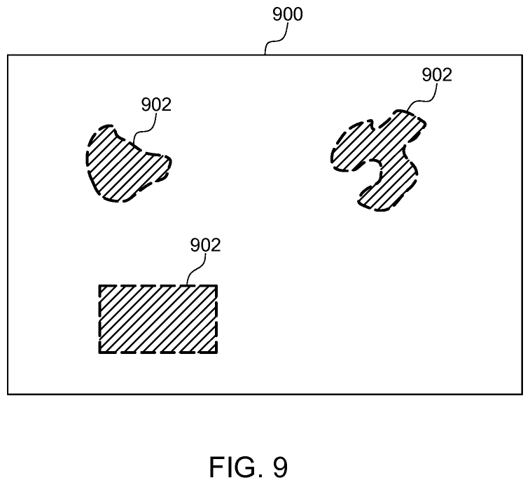

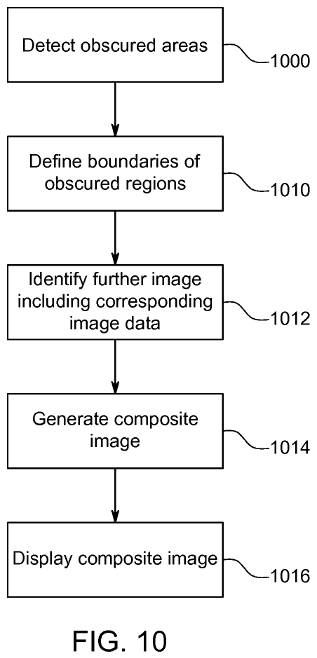

Referring now to FIGS. 9 and 10, a method of compensating for an obscured camera field of view will now be described. This method builds upon the above described approach for generating composite images including regions not directly visible within the live images obtained by a camera. In brief, the present invention compensates for obscured image regions by stitching in image data from another image into the obscured region to form a composite image.

FIG. 9 illustrates an image 900 captured by a first camera, such as one of cameras 110, 120 in FIG. 1 or camera 610 in FIG. 6. Within the image 900 are three obscured regions 902. Clearly the number, size and shaped of obscured regions may vary, as may the proportion of the image which may be obscured.

The compensation process begins with step 1000 of FIG. 10 in which obscured areas of the image are detected. This may alternatively be termed soiling detection. This may be readily done for a moving vehicle by comparing a live image with an historic image captured by the same camera at an earlier moment in time. One approach to detecting obscured areas involves flow analysis of camera images, where, as the vehicle moves, areas where pixels do not change or substantially do not change from one frame to the next may be detected. At the same time, other areas are subject to change—if no parts of the image change then either the vehicle is stationary or the camera is completely blocked. More generally, a current image may be compared to a previous image and where pixels or groups of pixels are the same (while others change) then it may be assumed that the lack of change is because light is being blocked from reaching that portion of the camera lens (or else the camera is capturing an image of the dirt or other matter on the lens or camera window). The unchanged areas may include a substantial portion of dark pixels where light is totally blocked. It will be appreciated that some portions of a detected region may not be completely obscured, but the image may be degraded by passing through dirt or dust. The skilled person will be well aware of techniques for comparing images and detecting areas when the image has not changed, for instance as may be typically used for motion analysis or video compression.

At step 1010 a boundary for at least one obscured region may be established. An obscured region may comprise a single obscured area of a screen. Alternatively, an obscured region may comprise a collection of obscured areas interspersed with unobscured areas. This may be particularly relevant where dirt has splashed onto a camera lens or window causing multiple splattered obscured areas. It may be computationally simpler to aggregate a number of small, close together obscured areas into a single obscured region. FIG. 9 shows three such obscured regions 902 in which the boundaries of each region are indicated by dashed lines. One such obscured region 902 is indicated as being rectangular. It will be appreciated that it is improbable that dirt obscures a rectangular portion of a camera's field of view. However, it may be that it is computationally similar to stitch together a composite image in which image data from another image is inserted into a squared off obscured region. The other two obscured regions 902 are shown as taking more complex shapes, on the assumption that given no other constraints it is desirable to retain as much of the original image captured by the camera as possible, and to minimise the amount of image data that must be inserted into the composite image. The skilled person will be well aware of suitable techniques for defining a region boundary.

Once the boundary of an obscured region is defined, at step 1012 a further image including corresponding image data may be identified. For a single camera system the only option is to identify an historic, buffered image in which the corresponding image data is captured in a different part of the image which is not obscured. For a multiple camera system, suitable image data may alternatively be identified in a live image from another camera which has a field of view overlapping the field of view of the first camera, and the overlapped portion at least partially encompasses the obscured region. Alternatively, an historic image captured by another camera may be identified including the corresponding image data. Clearly where historic images are used, either derived from the first camera or another camera, this is on the basis that the position of the vehicle has changed between the time at which the historic image was captured and the time of capture of the current image, the change in position resulting in the obscured portion of the environment surrounding the vehicle having been captured in an historic image (assuming of course that the historic image is not similarly obscured in the corresponding part of the field of view). It will be appreciated that where there are multiple obscured regions in an image obtained from a first camera then different images from different sources may be identified to provide the obscured image data. Furthermore, particularly where a single obscured image is large, it may be that different parts of the same obscured regions are filled from different images.

Where historic image data is used either from the same camera or another camera, optical flow analysis may be used to detect a movement vector which is used to substitute a historic image region that will show the view through the obscured region (or at least a simulation of the view that would have been obtainable at the point in time at which the historic image was captured). The use of historic image data requires that camera images have previously been buffered at the time at which camera soiling is detected.

In a further variant, a composite image may be generated in which image data from different sources are overlaid, for instance image data from another camera and an historic image. This may be desirable in a situation in which the historic image is of a higher quality but the live image data from another camera has the benefit of revealing objects that may have moved into the field of view since the historic image data was captured.

Once a further image has been identified at step 1012 then a composite image is generated at step 1014 through a process of stitching together the image from the first camera and image data from the further image. At step 1016 at least a portion of the composite image is displayed to the driver.

It will be appreciated that the process of determining a further image able to provide image data to fill an obscured region may be implemented using the approach described above in connection with FIGS. 1 to 6 concerning the stitching together of live and historic images to form a composite image including portions of the environment surrounding the vehicle which is not directly visible in the field of view of any camera. In particular, the use of an historic image from either the same camera or another camera in a multiple camera system to fill an obscured image region may comprise the same process of performing pattern recognition using a pattern recognition area to insert historical image data into the composite image, as is described in connection with FIG. 4. Where image data for an obscured image region is supplied by another live image from another camera with an overlapping field of view, it will be appreciated that the process may be simplified if the overlapping portions of the camera field of view are known in advance. Accordingly the system diagram of FIG. 6 may be appropriate for certain embodiments of the invention particularly in the event that historic images are to be used, given that in that case it is likely to be necessary to accurately detect the vehicle position in order to determine a pattern recognition area.

It will be further appreciated that where an obscured image region is filled with image data from another image to form a composite image, then it is likely to be necessary to perform various image manipulations including scaling, stretching, rotating or skewing the image data from the other image so as to fit correctly into the obscured region. Furthermore, in certain embodiments of the invention it may be desirable to perform the same process of adjustment of image properties to avoid composite image discontinuities as described above in connection with FIGS. 7 and 8.

In order to exemplify the present invention, embodiments will now be described in connection firstly for a single camera system and secondly for a multiple camera system.

### Single Camera System

A single camera system may be embodied in a typical reversing camera system, where a single vehicle-mounted camera is located at or towards the rear of the vehicle, for example in a tailgate or rear bumper. Water spray and dirt cannot be avoided when driving on wet roads or off-road tracks. While the present invention does not guarantee a perfectly clear view of the area behind the vehicle, following the process described above in connection with FIGS. 9 and 10 a series of successive images may be captured and buffered. Each image (or at least a proportion of images) may be compare to an earlier captured image to determine if the lens is obscured, and if so, a composite image may be generated to compensate, at least in part, for that obscuration.

It will be appreciated that the in one basic embodiment, the image correction system cannot start until the system determines that the vehicle is moving, as the system will require two or more frames that are known to have slightly different views. Specifically, movement of the vehicle may be separately detected, for instance using the position sensors 404 of FIG. 4. Successive images are buffered to permit an image processor to compare successive frames. The system compares these successive frames and looks for parts of the image that do not change, indicative of dirt or water on the lens. If a region of the image is determined by the system to be adversely affected by dirt on the lens then the system will use parts of buffered images matched and stitched into the current view so at to effectively replace the obscured part of the view with an image sliver having better clarity than would otherwise be available. These image slivers can be adjusted for white balance and colour corrected (along with other necessary processing such as cropping, scaling, stretching and skewing, together with other image property correction) so that they do not appear out of place to the user. As the vehicle moves, the corrected region of the image may be compensated sufficiently to allow the driver an increased interval between cleaning the lens or camera window.

When the system starts to correct the image using buffered image data, the user, such as the driver of the vehicle, may be notified, for instance by way of a visible warning on the display, that the image is being corrected using historical data, and that the driver should then proceed with greater caution. Advantageously, this will also help to let the driver know when they need to clean the lens. In an example, the displayed image may be artificially colourized to highlight that image correction is in progress. Any other visual indication may be used or other types of warning, such as an audible warning.

In an extension to the simple embodiment described above, images may be buffered and then stored for a longer period of time if the vehicle is stationary or even switched off, so as to provide historical images to begin again the process of detecting obscured regions and generating a composite image when the vehicle is switched on or resumes movement. As an extension, if obscured regions are detected when the vehicle is first switched on, and if those obscured regions are significant, then this may be a suitable time to generate a notification to the driver that they need to clean the camera lens before setting off on their journey.

It is noted above that it may be that only a portion of a composite image is displayed to the driver. It is not unusual for a camera to have a wider field of view than is strictly required. The required portion of the field of view may be cropped (also referred to as the remaining portions being masked). It will be appreciated that if the camera being used has a wider field of view, for instance than is typically used for the reversing view, then the image data from historic camera images in regions that are not typically displayed may also provide the necessary image data to compensate for obscured image regions. This additional image data may be used to augment the buffered image data. In this way, the total available image data collected by the camera may effectively cover a part of the vehicle path that has yet to be displayed to the driver. As such the time-delay, inherent with the replacement of obscured regions of a first image using historic image data can be reduced as the second image from which such image data is obtained may be more recent.

While the present invention cannot make reversing cameras impervious to dirt and spray, as there will ultimately come a point where they are significantly obscured, embodiments of the invention may allow for less frequent lens cleaning.

### Multiple Camera System

As described previously, a vehicle may be fitted with a plurality of cameras, each with its respective view of a region exterior to the vehicle. The cameras may be positioned so as to provide views to the front, rear and both left and right sides of the vehicle. Image processing is performed on these camera views to stitch them together and display them as a substantially 360 degree view of the surroundings of the vehicle, as illustrated in FIG. 2 and described in connection with FIG. 4 (optionally including historic images used to fill the obscured space under the vehicle).

In this arrangement, the camera views typically overlap at least slightly with the neighbouring camera about the vehicle. The images captured by each camera are stretched, cropped and/or resolved so as to provide a displayed view that can be readily understood by the driver. As described previously in connection with the single camera system, the image processor may further replace regions of the 360 degree view (referred to as an “image bowl” in the description of FIG. 2) which are otherwise obscured by dirt on one or more camera lenses. This may be achieved in one or both of two ways. Firstly, by storing parts of the image data captured by the cameras and buffering that image data, then using historic image data from another camera (for instance a neighbouring camera) to fill an obscured region in an image obtained from a first camera. Alternatively, image data from neighbouring cameras from overlapping fields of view that would otherwise be cropped out when generating the composite image may be used to fill an obscured region. Specifically, image data from an overlapping field of view may be matched using the clear view in the overlapping camera fields of view and used to replace the region of the view obscured by dirt. This use of image data from an overlapping field of view may comprise substituting image data in a narrowly constrained obscured region or the cropping and stitching line in each image may be shifted such that where a region is obscured in the view from one camera but clear in the view from another camera, the line is moved such that the clear view is used.

Using, at least in part, image data from an overlapping field of view to compensate for obscured regions when generating a composite image relies a little less on having historical image data in the buffer where the historical image data is spatially separated due to vehicle movement. Rather, the overlapping parts of the available image data are recognised by a self-calibrating function of the image processor, and so known redundant parts of the image data (those parts normally cropped out) can be called upon with less burden on the image processor to augment and enhance an otherwise obscured view. That is, where the vehicle cameras are arranged to capture a wider field of view than is required for a given display mode, the image processor can use image data that is otherwise not displayed to the driver so as to correct for an obscured lens with less latency than would otherwise result from using corrections based on historical image data.

Furthermore, a multiple camera system can use buffered image data from cameras mounted on the front of the vehicle to assist the driver during a reversing manoeuvre. More generally, the use of historic image data for obscured region compensation is not restricted to neighbouring or nearby cameras. As long as at least one of the cameras have captured the portion of the external environment required to compensate for the obscured region (and the memory is sufficient to buffer enough image frames), then even if the lens of the rear-view camera is badly soiled, a composite reversing camera view can be created. In an example, the driver brings the car to a halt from driving forwards and then selects reverse. The driver wishes to move the vehicle backwards, but the rear-view camera lens is dirty. With this arrangement, suitable image data from the buffered forward facing camera can be used to compensate for obscuration of the rear-view camera. As an extension of this, if the rear-view camera is entirely obscured, the system may provide the driver with a reverse replay of front view camera data, time matched and imaged matched using position data and data gleaned from the views recorded from the side-view cameras, to create a view of the surroundings behind the vehicle based on historical camera views taken by the front-view camera. In this case it desirable to notify the driver that this compensation is being applied as it will not show any new event or obstruction that enters the area behind the vehicle during the reversing manoeuvre. As an example, such a generation of an entirely simulated rear view may be useful on very narrow, single-track lanes which rely on passing places to enable two-way traffic. In in a situation in which the vehicle detects that it is traversing such a road, for instance through GPS data and optionally corroborated by side-view cameras, buffering of camera image data may be extended, for instance for side-view cameras from the side on which the passing places are provided and especially where the system has determined that one or more camera lenses are partially obscured.

It will be appreciated that embodiments of the present invention can be realised in the form of hardware, software or a combination of hardware and software. In particular, the method of FIGS. 4, 7, 8 and 10 may be implemented in hardware and/or software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A display method for use in a vehicle, the method comprising:
obtaining a first image showing a region external to the vehicle from a first image capture device;
detecting an obscured region of the first image for which a portion of the field of view of the first image is obscured at least in part;
identifying image data in a second image corresponding to the obscured region;
generating a composite image from the first image and the identified image data; and
displaying at least part of the composite image.

2. A display method according to claim 1, wherein detecting an obscured region comprises comparing the first image to a further image obtained from the first image capture device, the first and further images being captured at different points in time.

3. A display method according to claim 2, wherein detecting an obscured region further comprises detecting corresponding portions of the first image and the further image which are the same while other corresponding portions of the first image and the further image are different.

4. A display method according to claim 2, wherein detecting an obscured region further comprises defining a boundary encompassing said corresponding portions of the first image and the further image which are the same.

5. A display method according to claim 1, wherein the second image is obtained from the first image capture device or a second image capture device having a different field of view relative to the first image capture device, the first and second images being captured at different points in time.

6. A display method according to claim 1, wherein the second image is obtained from a second image capture device at the time of capture of the first image, the fields of view of the first and second image capture devices overlapping and the region of overlap at least partially encompassing the obscured region.

7. A display method according to claim 6, wherein either or both the first and second image capture devices are mounted upon or within the vehicle to capture images of the environment external to the vehicle.

8. A display method according to claim 1, further comprising:
determining positions of the vehicle at the time the first and second images are captured; and
storing an indication of the determined positions of the vehicle.

9. A display method according to claim 1, wherein generating a composite image comprises matching portions of the first image and the second image.

10. (canceled)

11. A display method according to claim 9, wherein matching portions of the first image and the second image comprises performing pattern matching to identify features present in both the first image and the second image.

12. (canceled)

13. A display method according to claim 11, further comprising determining a pattern recognition region within the first image including the obscured region, wherein determining the pattern recognition region comprises determining coordinates for the pattern recognition region according to a current position of the vehicle.

14. A display method according to claim 13, wherein determining a pattern recognition region further includes receiving a signal indicating an orientation of the vehicle and adjusting the pattern recognition region coordinates according to the vehicle orientation.

15. A display method according to claim 1, further comprising:
obtaining at least one image property for each of the first and second images;
calculating an image correction factor as a function of the at least one image property for each of the first and second images; and
adjusting the appearance of the first image or the second image according to the calculated image correction factor.

16. A display method according to claim 15, wherein the at least one image property is indicative of a characteristic of the image, a setting of an image capture device used to capture the image or an environmental factor at the time the image was captured.

17. (canceled)

18. A display method according to claim 1, wherein generating a composite image further comprises using identified image data from the second image and at least one third image within the obscured region.

19. A display method according to claim 1, further comprising storing at least a predetermined number of images obtained from the first image capture device at different points in time.

20. A computer program product storing computer program code which is arranged when executed to implement the method of claim 1.

21. A display apparatus for use with a vehicle, the apparatus comprising:
a first image capture device arranged to obtain a first image showing a region external to the vehicle;
a display means; and
a processing means arranged to:
detect an obscured region of the first image for which a portion of the field of view of the first image capture device which is obscured at least in part;
identify image data in a second image corresponding to the obscured region;
generate a composite image from the first image and the identified image data; and
cause the display means to display at least part of the composite image.

22. A display apparatus according to claim 21, wherein the processing means is arranged to detect the obscured region by comparing the first image to a further image obtained from the first image capture device, the first and further images being captured at different points in time.

23. A vehicle comprising the display apparatus of claim 21.

24. (canceled)
